(19) United States
(12) Patent Application Publication
(10) Pub. No.: US 2026/0253077 A1
(43) Pub. Date: Aug. 27, 2026

(54) SYSTEM AND A METHOD FOR FACILITATING PRICTIONLESS AND SECURE TRANSACTIONS

(71) Applicant: Agashe Global LLC, Austin, TX (US)

(72) Inventor: Mandar Agashe, Pune (IN)

(21) Appl. No.: 19/644,182

(22) Filed: Apr. 10, 2026

Related U.S. Application Data
(63) Continuation-in-part of application No. 18/037,877, filed on Dec. 20, 2022, now Pat. No. 12,626,238.

(30) Foreign Application Priority Data
Dec. 22, 2021 (IN) 202121060001

(51) Int. Cl. G06Q 20/40

(52) U.S. Cl. CPC G06Q 20/4012; G06Q 2220/00

(57) ABSTRACT

A system (100) and method (200) for facilitating frictionless and secure electronic transactions between registered users is disclosed. A payment application (102), executable on user electronic devices (10a, 10b), enables user registration, transaction initiation, and confirmation through interfaces (104). A registration module captures personal and financial details, which are converted into tokens by a tokenization platform and stored in a first memory (106a). Tokens of previously transacted users are stored in a second memory (106b) to enable seamless repeat transactions. A transaction server (108) generates a time-bound verification code via a verification code generation module (110), validates the code through a verification code checking module (112), and authorizes payment through an authorization module (112c). Upon approval from the first user's bank (40) or a payment gateway, funds are transferred to the second user bank (30), and a notification module (118) confirms the transactions

### CROSS-REFERENCE TO RELATED APPLICATION(S)

This application is a Continuation-in-Part of the U.S. patent application Ser. No. 18/037,877 filed on May 19, 2023, entitled, “A SYSTEM FOR SECURE TRANSACTION PROCESSING AND A METHOD THEREOF”, which is the national phase of PCT Patent Application No. PCT/IB2022/062520 filed on Dec. 20, 2022, titled, “A SYSTEM FOR SECURE TRANSACTION PROCESSING AND A METHOD THEREOF” which claims priority from Indian Patent Application No. 202121060001 filed on Dec. 22, 2021, entitled, “A SYSTEM FOR SECURE TRANSACTION PROCESSING AND A METHOD THEREOF” the entire disclosures of each of which are hereby incorporated herein by reference.

### FIELD

The present disclosure relates to the field of financial transaction systems. More particularly, focuses on the digital payment mode.

### DEFINITION

As used in the present disclosure, the following terms are generally intended to have the meaning as set forth below, except to the extent that the context in which they are used indicates otherwise.

Registered User: The term “registered user” refers to a user who has been enrolled in the system by providing personal and financial details and whose details are stored in the system for enabling financial transactions.

Frictionless: The term “frictionless” refers to a digital payment process that enables users to initiate, verify, and complete transactions seamlessly and efficiently, without the need to repeatedly enter sensitive financial information, while maintaining security through tokenization and verification processes.

First User: The term “first user” refers to a registered user initiating a financial transaction for the transfer of funds.

Second User: The term “second user” refers to a registered user receiving funds in a financial transaction initiated by a first user.

Electronic Device: The term “electronic device” refers to any computing device capable of executing a payment application and communicating with a transaction server, including but not limited to mobile phones, tablet computers, desktop computers, laptop computers, point-of-sale devices and automated teller machines.

Near Field Communication (NFC): The term “NFC” refers to Near Field Communication, a short-range wireless technology that allows devices to exchange data or make payments by bringing them very close together, typically within a few centimeters.

Token: The term “token” refers to a generated value representing financial details of a user in a non-readable form, wherein the token is used in place of the actual financial details during transaction processing.

Tokenization: The term “tokenization” refers to a process of converting financial details into tokens such that the original financial details are not exposed during transaction processing.

Transaction: The term “transaction” refers to a payment-related exchange in which money is transferred from one party to another for goods, services, or obligations

Verification Code/PIN: The term “verification code” or “PIN” refers to a transaction-specific code generated for enabling authorization of a financial transaction.

The above definitions are in addition to those expressed in the art.

### BACKGROUND

The background information herein below relates to the present disclosure but is not necessarily prior art.

Electronic financial transactions have become widely adopted for the transfer of funds between individuals and merchants. Users increasingly rely on electronic devices and digital platforms for performing financial transactions due to convenience and accessibility.

Conventional electronic payment systems generally require users to repeatedly enter financial details or select payment credentials during transaction processing. Such requirements may result in inconvenience and inefficiency, particularly for users who frequently perform transactions.

Existing systems often involve transmission or storage of financial information such as bank account details, card numbers or other financial credentials, which may increase the risk of unauthorized access or misuse. Exposure of financial details during transactions may result in security concerns and may discourage users from adopting digital payment systems. In many cases, personal and financial details of users are required to be shared between transacting parties or transmitted through multiple intermediaries during transaction processing, thereby increasing the possibility of data compromise.

Further, many existing systems require users to manually identify recipients and verify recipient details before initiating transactions. Such procedures may increase transaction time and may lead to errors in entering recipient information. Incorrect entry of recipient details may result in failed transactions or unintended transfer of funds.

Additionally, existing systems often provide security measures that may involve multiple steps, which may reduce ease of use and increase transaction complexity. While such security mechanisms may improve protection of financial data, they may also reduce the efficiency and user-friendliness of transaction systems.

Therefore, there is a need a system and a method for facilitating frictionless and secure transactions that alleviates the aforementioned drawbacks.

### OBJECTS

Some of the objects of the present disclosure, which at least one embodiment herein satisfies, are as follows:

It is an object of the present disclosure to ameliorate one or more problems of the prior art or to at least provide a useful alternative.

An object of the present disclosure is to provide a system for facilitating secure transaction processing between registered users.

Another object of the present disclosure is to provide a system that enables frictionless transfer of funds between users.

Still another object of the present disclosure is to provide a system that reduces the need for repeated entry of financial details.

Yet another object of the present disclosure is to provide a system that enables secure storage of financial information.

Still another object of the present disclosure is to provide a system that utilizes tokenized financial information for transaction processing.

Yet another object of the present disclosure is to provide a system that enables secure authorization of transactions.

Still another object of the present disclosure is to provide a system that enables efficient repeated transactions between users.

Yet another object of the present disclosure is to provide a system that enables the convenient selection of previously transacted users.

Still another object of the present disclosure is to provide a system that improves transaction security while maintaining ease of use.

Yet another object of the present disclosure is to provide a system that enables the transfer of funds without exposing financial details.

Other objects and advantages of the present disclosure will be more apparent from the following description, which is not intended to limit the scope of the present disclosure.

### SUMMARY

The present disclosure relates to a system and method for facilitating frictionless and secure electronic transactions between registered users. The disclosure provides a payment platform that enables seamless transfer of funds between a first user and a second user through a secure, token-based architecture without requiring repeated entry of sensitive financial information.

In one aspect, a payment application is installed on electronic devices of registered users and provides user interfaces for registration, transaction initiation, and transaction confirmation. During registration, user details, including personal and financial information are captured and securely processed. Financial information is converted into tokens through a tokenization process to ensure that sensitive data is not stored or transmitted in a readable form.

The system maintains secure storage of generated tokens and, upon successful transactions, enables storage of tokens corresponding to previously transacted users. This allows a user to select a previously transacted counterparty from a stored list and initiate future transactions without re-entering financial details, thereby enhancing convenience while maintaining security.

To initiate a transaction, the system enables selection of the payment application as the transaction mode and optionally allows selection of a registered counterparty from stored records. A unique verification code or personal identification number (PIN) is generated for the transaction. The verification code is associated with a specific transaction amount and intended recipient and is configured to remain valid only for a predetermined time period or until completion of the transaction.

The generated verification code is securely transmitted to the intended recipient device. Upon receipt, the system verifies the code by matching it with the originally generated code and ensuring that it corresponds to the specific recipient and transaction amount. The verification mechanism prevents unauthorized use of the code by other users and restricts transfer of funds exclusively to the designated recipient account.

Once verification is successful, the system extracts the relevant token corresponding to the transaction and communicates with the payer's financial institution or a payment gateway for authorization. A notification is transmitted to the payer for approval of the intended transaction, and upon successful authorization, funds are transferred from the payer's account to the recipient's account. Confirmation of the successful transaction is then communicated to the relevant users.

In certain embodiments, the system includes a searching mechanism that retrieves stored tokens of previously transacted users when a transaction is initiated, thereby streamlining repeat transactions. The platform further enables users to update their personal and financial details through the application.

The disclosure also contemplates that any registered user may function as a payer/first user in one transaction and as a recipient in another transaction. The recipient may include peer users, online or offline merchants, establishments, or automated teller machines, thereby enabling both peer-to-peer payments and merchant or cash withdrawal transactions.

Overall, the disclosed system and method provide a secure, token-based, verification-driven transaction framework that reduces friction in digital payments while enhancing protection of financial information.

### BRIEF DESCRIPTION OF THE ACCOMPANYING DRAWING

A system and method for facilitating frictionless and secure electronic transactions, of the present disclosure will now be described with the help of the accompanying drawing in which:

FIG. 1 illustrates a block diagram of the system, in accordance with the present disclosure;

FIG. 2 illustrates a flowchart showing the first user's functionality, in accordance with the present disclosure;

FIG. 3 illustrates a flowchart showing the second user's functionality, in accordance with the present disclosure; and

FIGS. 4A to 4E illustrate a method for facilitating frictionless and secure electronic transactions, in accordance with the present disclosure.

### LIST OF REFERENCE NUMERALS

100 System
10 Electronic device
10a Electronic device of the registered first user
10b Electronic device of registered second user
30 Second user bank
40 First user bank
102 Payment application
104 user Interface/user application interface
105 Tokenization platform
106a First memory
106b Second memory
108 Transaction server
109a First selection module
109b Second selection module
110 Verification code generation module
111 Transmission module
112 Verification code checking module
112a Comparator
112b Extractor module
112c Authorization module
113 Verification code receiving module
114 Transaction amount adding module
115 Searching module
116 Login Module
117 Instructor module
118 Notification module
119 Execution module
200-236 Method and steps
300-344 Flowchart and steps
400-432 Flowchart and steps

### DETAILED DESCRIPTION

Embodiments, of the present disclosure, will now be described with reference to the accompanying drawing.

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, elements, modules, units and/or components, but do not forbid the presence or addition of one or more other features, elements, components, and/or groups thereof.

When an element is referred to as being “engaged to,” “connected to,” or “coupled to” another element, it may be directly engaged, connected, or coupled to the other element. As used herein, the term “and/or” includes any and all combinations of one or more of the associated listed elements.

Electronic financial transactions have become widely adopted for transferring funds between individuals and merchants due to their convenience and accessibility. However, conventional electronic payment systems often require users to repeatedly enter financial details or select payment credentials, which can reduce efficiency, especially for frequent users. Many existing systems involve the transmission or storage of sensitive financial information such as bank account or card details, increasing the risk of unauthorized access and data compromise. Additionally, users are often required to manually identify and verify recipients, which can increase transaction time and lead to errors or unintended transfers. Although security measures are implemented to protect financial data, they frequently involve multiple steps that may reduce ease of use and overall transaction efficiency.

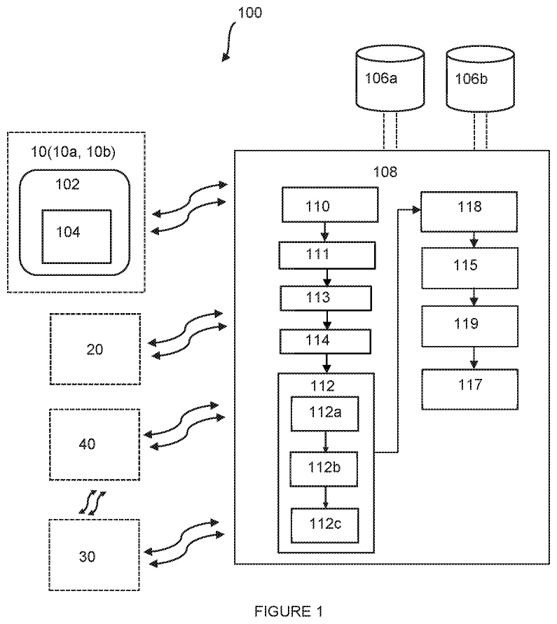

Therefore, the present disclosure envisages a system and a method for facilitating frictionless and secure transactions (hereinafter referred to as system (100), method (200)). The present disclosure is explained with reference to FIGS. 1 to 4E.

The present disclosure relates to a system (100) and a method (200) for facilitating frictionless and secure transaction processing between a registered first user and a registered second user.

The system (100) enables secure transfer of funds between a first user bank (40) and a second user bank (30) by using tokenized financial details and transaction-specific verification codes/PIN, thereby avoiding disclosure of sensitive financial information during the transaction process. The system (100) is configured to provide a secure, efficient and user-friendly mechanism for conducting financial transactions between registered users while ensuring authentication and authorization at multiple stages.

Referring to FIG. 1, the system (100) comprises a payment application (102), a first memory (106a), a second memory (106b), and a transaction server (108) hosting the payment application (102), a verification code generation module (110), verification code checking module (112) comprises a comparator (112a), an extractor module (112b), and an authorization module (112c), a registration module, a login module (116), a notification module (118), a searching module (115), an execution module (119), and an Instructor module (117).

The payment application (102) is configured to be stored and executed on electronic devices (10) associated with registered users.

The payment application (102) is configured to provide interfaces (104) enabling interaction between users and the system (100). The payment application (102) is configured to enable a registered first user to initiate a financial transaction and enable a registered second user to receive and process a transaction request. The payment application (102) is configured to communicate with the transaction server (108) through a communication network to enable processing of transactions.

In one embodiment, the payment application (102) is further configured to allow registered users to update stored personal details and financial details.

In an embodiment, the payment application (102) is configured to store locally cached information relating to previously transacted registered second users to enable faster access and improved transaction efficiency.

In another embodiment, the payment application (102) is configured to provide transaction history and status information to registered users.

In yet another embodiment, the payment application (102) is configured to provide authentication mechanisms including password authentication, biometric authentication or device-based authentication to provide secure access.

In one embodiment, the payment application (102) can be a mobile or web application executed on an electronic device (10) such as a mobile phone, tablet, computer, or laptop, capable of accessing financial products, services, or information stored on the server (108) and memory (106). Upon execution, the payment application (102) provides a first user interface (104) to facilitate users registering and adding financial accounts with the transaction server (108) for secure payment transactions. The payment application (102) further enables a registered user to tokenize financial accounts via a tokenization platform.

In an embodiment, the electronic device (10) can include, but is not limited to, a mobile phone, tablet, laptop, desktop computer, wearable device, or any other electronic device capable of processing data and communicating with the transaction server (108) via a communication network. The electronic device (10) is configured to store locally cached data to improve transaction efficiency, provide transaction history, and support authentication mechanisms including passwords, PINs, or biometric verification such as fingerprint, facial, iris, or voice recognition.

In an embodiment of the present disclosure, the system (100) comprises a registration module configured to enroll registered first users and registered second users into the system (100). The registration module is configured to capture user details, including personal identification details, device identification details and financial details associated with users. The registration module associates captured details with a unique user profile. The registration module is configured to validate the captured information prior to completion of registration. In an embodiment, the registration module is configured to verify the identity of users using authentication credentials or external verification systems. In another embodiment, the registration module is configured to allow modification or updating of stored personal details and financial details.

In another embodiment, for registration, the payment application (102) prompts the user to enter registration details via the first user interface (104), including personal details and financial accounts. Personal details can include, but are not limited to, name, mobile number, email ID, photograph, Permanent Account Number, and date of birth. Financial accounts can include bank account details, debit/credit/prepaid card numbers, card validity details, CVV, internet banking credentials, login credentials for financial service accounts, Virtual Payment Address (VPA)/Unified Payments Interface (UPI) ID, PayPal ID, Zelle ID, other transaction IDs, and/or tokens of financial accounts. The payment application (102) then sends the received registration details to the transaction server (108).

In an embodiment, the transaction server (108) comprises a login module (116) configured to facilitate secure access to the payment application (102) by enabling a registered user to create, modify, and manage login credentials through the first user interface (104). The login module (116) is configured to authenticate the registered user prior to permitting access to transaction functionalities of the payment application (102), wherein authentication may be performed using at least one of a login ID and password, a pre-set application PIN, or a biometric credential including fingerprint, facial recognition, iris scan, retina pattern, voice sample, finger vein pattern, or palm vein pattern. The login module (116) is further configured to restrict access after a predetermined number of failed login attempts and optionally trigger a re-authentication or account recovery process.

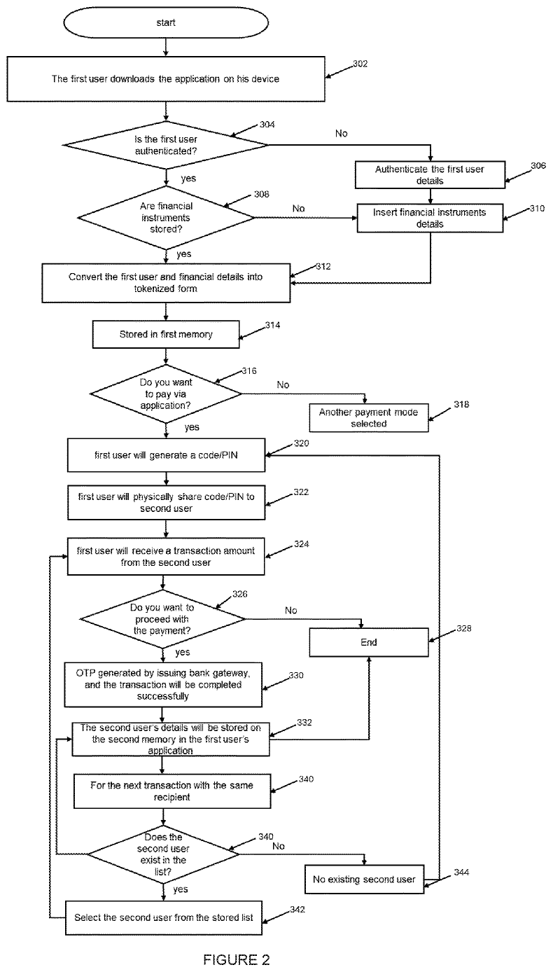

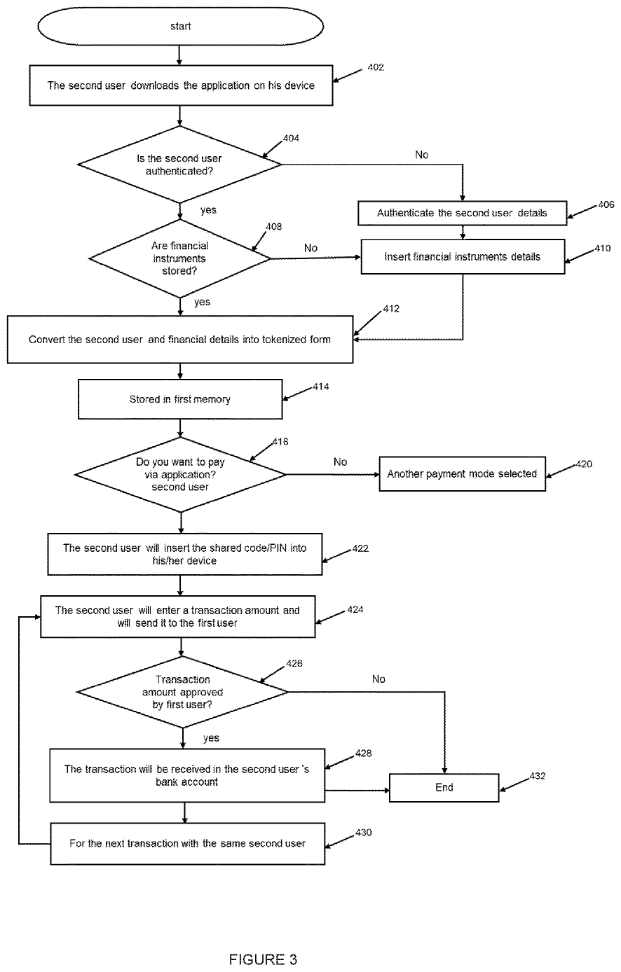

Referring to FIGS. 2 and 3, the first user interface (104) provided by the payment application (102) is configured to present interactive graphical elements enabling user registration, login, selection of financial accounts, generation of verification codes/PINs, and authorization of transactions through swiping actions, PIN entry, or biometric confirmation. The first user interface (104) may comprise a first user application interface (104a) associated with a payer/first user and a second user application interface (104b) associated with a beneficiary, each configured to securely display transaction details, receive verification codes/PINs, and provide real-time notifications of transaction status via the notification module (118).

The tokenization platform (105) is configured to convert captured financial details into corresponding tokens. The tokenization platform (105) is configured to generate tokens representing financial instruments associated with registered users such that financial details are not stored in readable form within the system (100). The tokenization platform (105) maintains a secure mapping between generated tokens and corresponding financial details and transmits the generated tokens to a first memory (106a). In an embodiment, the tokenization platform (105) is configured to generate different tokens for different financial instruments associated with the same user. In another embodiment, the tokenization platform (105) is configured to periodically refresh or regenerate tokens to enhance transaction security. In yet another embodiment, the tokenization platform (105) is configured to invalidate tokens when associated financial details are modified or removed.

In an embodiment of the present disclosure, the system (100) comprises the first memory (106a) configured to store tokens corresponding to registered users. The first memory (106a) stores tokenized representations of financial details in a secure form and prevents the storage of original financial details in a readable form. The first memory (106a) is accessible to the transaction server (108) for enabling transaction authorization. In an embodiment, the first memory (106a) is configured to store associations between tokens and registered users. In another embodiment, the first memory (106a) is configured to store transaction-related metadata associated with tokens.

The second memory (106b) is configured to store tokens corresponding to registered second users associated with previously completed transactions. The second memory (106b) stores tokens corresponding to registered second users in association with registered first users. When a successful transaction is completed between a registered first user and a registered second user, the token corresponding to the registered second user is stored in the second memory (106b) in association with the registered first user. The second memory (106b) enables the registered first user to initiate subsequent transactions without re-entering financial details.

In an embodiment, the second memory (106b) is configured to store identifiers corresponding to registered second users to enable the generation of a stored list of registered second users. In another embodiment, the second memory (106b) is configured to remove tokens corresponding to inactive or deleted users.

The transaction server (108) is configured to host the payment application (102) and enables transactions between registered users. The transaction server (108) is configured to coordinate communication between electronic devices (10), financial institutions and system modules to enable transaction processing. The transaction server (108) is configured to execute transaction workflows and ensure proper sequencing of transaction operations.

The First selection module (109a) is configured to enable a registered first user and a registered second user to select the payment application (102) as a mode for enabling a transaction. The First selection module (109a) is configured to register the selection of the payment application (102) as the transaction mode and initiate transaction processing. In an embodiment, the First selection module (109a) is configured to detect availability of the payment application (102) on devices associated with users.

The Second selection module (109b) is configured to enable the registered first user to optionally select a registered second user from the second memory (106b). The Second selection module(109b) is configured to retrieve tokens corresponding to registered second users stored in the second memory (106b) and present corresponding registered second users to the registered first user. In an embodiment, the Second selection module(109b) is configured to enable manual entry of a registered second user when the registered second user is not stored in the second memory (106b).

The verification code generation module (110) is configured to generate a verification code or personal identification number. The verification code generation module (110) is configured to generate a unique verification code associated with a specific transaction. The verification code generation module (110) is configured to display the generated verification code on the device (10a) associated with the registered first user. The verification code generation module (110) is configured to associate the generated verification code with a predetermined transaction amount and a specific registered second user. The verification code generation module (110) is configured to ensure that the generated verification code remains valid only for a predetermined time period and automatically expires after the predetermined time period or completion of the transaction. In an embodiment, the verification code generation module (110) is configured to generate random or pseudo-random verification codes to enhance transaction security.

The Transmission module (111) is configured to transmit the generated verification code or PIN to the device (10b) associated with the registered second user. The Transmission module (111) is configured to transmit the verification code through a secure communication channel.

In an embodiment, the Transmission module (111) is configured to encrypt the verification code prior to transmission. In another embodiment, the Transmission module (111) is configured to retransmit the verification code if delivery confirmation is not received.

The Verification code receiving module (113) is configured to receive the verification code or PIN entered on the device (10b) associated with the registered second user. The Verification code receiving module (113) is configured to forward the received verification code to the verification code checking module (112).

In an embodiment, the Verification code receiving module (113) is configured to validate the formatting or structure of the received verification code before forwarding the verification code for verification.

The Transaction amount adding module (114) is configured to generate or receive a transaction amount and link the transaction amount with the generated verification code or PIN. The Transaction amount adding module (114) is configured to ensure that the verification code is usable only for the linked transaction amount.

In an embodiment, the Transaction amount adding module (114) is configured to prevent modification of the transaction amount after generation of the verification code.

The verification code checking module (112) is configured to verify the received verification code and authorize the transaction. The verification code checking module (112) comprises a comparator (112a) configured to receive the verification code entered on the device (10b) associated with the registered second user and match the received verification code with the generated verification code.

In an embodiment, the comparator (112a) is configured to generate a match result indicating whether the received verification code corresponds to the generated verification code.

In an embodiment, the comparator (112a) is configured to reject verification codes after a predetermined number of unsuccessful attempts.

In an embodiment, the verification code checking module (112) further comprises an extractor module (112b) configured to extract a token associated with the verification code from the first memory (106a). The extractor module (112b) is configured to identify the token corresponding to the registered second user associated with the verification code.

In an embodiment, the extractor module (112b) is configured to retrieve additional transaction information associated with the token.

In an embodiment, the verification code checking module (112) further comprises an authorization module (112c) configured to send the extracted token to the first user bank (40) or to a payment gateway or payment aggregator linked to the registered second user for approval of the transaction. The authorization module (112c) is configured to enable transfer of funds from the first user bank (40) to the second user bank (30). The authorization module (112c) is configured to authorize the transaction only when the verification code is received from the electronic device (10b) associated with the registered second user. The authorization module (112c) is configured to reject the verification code when used by a registered second user other than the registered second user associated with the verification code. The authorization module (112c) is configured to ensure that the verification code enables transfer of the predetermined transaction amount exclusively to the bank account associated with the registered second user.

In an embodiment, the authorization module (112c) is configured to record authorization responses received from financial institutions.

In an embodiment, the transaction data comprises a register user identifier, at least one of a transaction identifier, the financial account of the registered user, the transaction amount, details of the online/offline merchant or ATM or one or more registration details of a second registered user with whom the payment transaction is being performed.

The notification module (118) is configured to cooperate with the authorization module (112c) to transmit details of an intended financial transaction to the device associated with the registered first user for approval. The notification module (118) is configured to notify the registered first user of successful completion of a transaction. The notification module (118) is further configured to transmit details of the registered second user involved in the transaction.

In an embodiment, the notification module (118) is configured to generate transaction alerts and status updates.

The searching module (115) comprises at least one crawler and extractor pair configured to crawl over the second memory (106b) and extract an identified token of a stored registered second user. The Searching module (115) is configured to identify tokens corresponding to previously transacted registered second users and provide the identified tokens to the transaction server (108).

In an embodiment, the Searching module (115) is configured to perform indexed searches to improve retrieval efficiency.

In an embodiment of the present disclosure, the system (100) comprises an Execution module (119) configured to initiate operation of the searching module (115) when a registered first user initiates a financial transaction with a registered second user. The Execution module (119) is configured to control the timing of execution of the Searching module (115) and ensure that relevant tokens are identified prior to generation of the verification code.

In an embodiment, the execution module (119) is configured to manage transaction states during processing.

In an embodiment of the present disclosure, the system (100) comprises an instructor module (117) configured to instruct the verification code generation module (110) to transmit a generated verification code or PIN to the Verification code receiving module (113) of the registered second user whose token has been identified. The instructor module (117)is configured to initiate the payment gateway associated with the registered first user after notification to the registered first user and approval of the transaction. The instructor module (117) is configured to control the sequence of transaction operations and ensure that authorization is initiated only after completion of verification steps.

In an embodiment, the instructor module (117) is configured to coordinate interactions between modules of the transaction server (108).

In an embodiment of the present disclosure, the system (100) enables the registered second user to include at least one of a peer user, an online merchant, a merchant establishment or an automated teller machine.

In an embodiment, the verification code generation module (110) is configured to generate a verification code enabling withdrawal of funds from an automated teller machine using the payment application (102).

In an embodiment, the system (100) is configured to facilitate secure transaction processing for e-commerce transactions through integration with a merchant server (70) hosting an e-commerce website (60), wherein a registered user selects a payment option associated with the payment application (102), generates a one-time verification code/PIN via the verification code generation module (110), and enters the verification code/PIN on a merchant interface (20), such that financial account details are not shared with the merchant server (70).

In an embodiment, the system (100) is configured to facilitate person-to-merchant (P2M) transactions at a retail outlet, wherein a merchant receives a verification code/PIN generated by a registered user through the payment application (102), enters the verification code/PIN and transaction amount into a point-of-sale terminal, and the transaction server (108) validates the verification code/PIN prior to authorization.

In an embodiment, the system (100) is configured to facilitate peer-to-peer (P2P) transactions between a first registered user and a second registered user, wherein the first registered user generates and communicates a verification code/PIN to the second registered user, and the transaction server (108) authorizes transfer of funds upon successful matching of the verification code/PIN by the comparator (112a).

In an embodiment, the system (100) is configured to facilitate automated teller machine (ATM) withdrawals, wherein a registered user selects a withdrawal option on an ATM interface, generates a verification code/PIN through the payment application (102), enters the verification code/PIN at the ATM interface, and upon successful verification by the verification code checking module (112), the transaction server (108) enables withdrawal of a specified amount without requiring insertion of a physical payment card.

In an embodiment, the system (100) is configured to issue a dedicated payment card associated with the payment application (102), wherein the payment card is recognizable by a point-of-sale system and enables merchants who do not use the payment application (102) to process transactions by entering a verification code/PIN provided by the registered user.

In an embodiment, the system (100) is configured to store customer registration details and merchant registration details in separate memory segments within the memory (106) or in distinct memory devices communicatively coupled to the transaction server (108), wherein each registered entity is associated with a unique identifier indicative of its role as a customer, merchant, or both.

In an embodiment, the first user bank (30) is configured to perform second-level authentication by generating and transmitting a one-time password (OTP) to the electronic device (10) of the registered user after receipt of transaction data from the second user bank (40) or payment gateway, and wherein completion of the transaction is contingent upon successful validation of the OTP.

In an embodiment, the communication between the payment application (102), the transaction server (108), the second user bank (40), the first user bank (30), and merchant server (70) is carried out through secure wired or wireless communication networks including at least one of internet-based communication, Near Field Communication (NFC), Wi-Fi, Bluetooth, LTE, CDMA, UMTS, or GSM protocols.

Similarly, In an embodiment, the system (100) is configured to facilitate frictionless subsequent e-commerce transactions, wherein a registered user selects a previously used payment option associated with the payment application (102), and the transaction server (108) retrieves the stored verification credentials from the first memory (106a) or second memory (106b) without requiring the user to re-enter personal or financial details, such that the transaction is authorized seamlessly while maintaining security.

In an embodiment, the system (100) is configured to enable subsequent P2M transactions at a retail outlet, wherein a merchant inputs the transaction amount into the point-of-sale terminal, and the transaction server (108) automatically validates the registered user's stored verification credentials from the first memory (106a) or second memory (106b) to authorize the transaction without prompting for an OTP or PIN, while still ensuring compliance with the first-level and second-level authentication protocols.

In an embodiment, the system (100) is configured to facilitate subsequent P2P transactions between a first registered user and a second registered user, wherein the first registered user selects a previously used payment method or verification code/PIN, and the transaction server (108) authorizes transfer of funds based on the previously stored credentials, such that frictionless transfer is achieved without requiring repeated verification input from the first or second registered user.

In an embodiment, the system (100) is configured to facilitate subsequent ATM withdrawals, wherein a registered user selects a withdrawal option on an ATM interface, and the transaction server (108) retrieves the stored verification credentials from memory (106a or 106b) to authorize the withdrawal seamlessly, thereby eliminating the need to enter a verification code/PIN for each transaction, while still enforcing risk-based checks by the first user bank (30) or second user bank (40).

In an embodiment, the first user bank (30) and second user bank (40) are configured to enable frictionless second-level authentication by automatically verifying subsequent transactions using stored user authentication tokens and transaction history from memory (106a or 106b), wherein completion of the transaction is contingent upon risk-based validation rather than repeated OTP entry.

In an embodiment, the communication between the payment application (102), the transaction server (108), the first user bank (30), the second user bank (40), and merchant server (70) for subsequent transactions is carried out through secure wired or wireless communication networks, including at least one of internet-based communication, Near Field Communication (NFC), Wi-Fi, Bluetooth, LTE, CDMA, UMTS, or GSM protocols, while ensuring that frictionless transactions remain secure and privacy-compliant.

In an embodiment, the first memory (106a) cooperates with the transaction server (108) to maintain a database comprising a first lookup table (110). The first lookup table (110) includes a list of user identifiers associated with registered users and corresponding registration details for each registered user. The registration details include personal information, financial account information, and tokens corresponding to the financial accounts (112).

During a transaction, the transaction server (108) facilitates a first-level authentication of the registered user. The acquirer bank (40) (second user bank) or a payment gateway (42) sends transaction details to the first user bank (30) (first user bank), which may perform second-level authentication to further verify the user and the associated financial accounts. For example, the first user bank (30) may generate and send a one-time password (OTP) to the registered user, who approves the transaction by entering the OTP via the payment gateway.

Accordingly, the first-level authentication is performed by the transaction server (108), and the second-level authentication is performed by the first user bank (30) (first user bank), thereby providing a multi-layered security mechanism for transaction approval.

In an embodiment, the second memory (106b) cooperates with the transaction server (108) to store a database comprising a second lookup table (116). The second lookup table (116) includes a list of user identifiers associated with transacted second users of the second user bank (40) and corresponding registration details for each second registered user in tokenized form. The registration details include transacted second users' personal information, financial account information, and tokens corresponding to the financial accounts (118).

During a transaction, the transaction server (108) performs a first-level authentication of the registered user of the second user bank (40) using the second lookup table (116). The acquirer bank (40) or payment gateway (42) sends transaction details to the issuing bank (30), which may perform a second-level authentication to further verify the user and the associated financial accounts. For example, the first user bank (30) may generate and send a one-time password (OTP) to the registered user, who approves the transaction by entering the OTP via the payment gateway.

Accordingly, the first-level authentication is performed by the transaction server (108) using the second lookup table (116) of the second memory (106b), while the second-level authentication is performed by the first user bank (30) or second user bank (40), providing a secure multi-layered transaction approval mechanism.

In an embodiment, the payment application (102) is configured to support Near Field Communication (NFC)-based transactions, wherein the electronic device (10a) of a registered first user includes an NFC module configured to establish short-range wireless communication with an NFC-enabled electronic device (10b) or point-of-sale terminal associated with a registered second user; upon selection of an NFC mode through the interface (104), the electronic device (10a) is brought into proximity with the electronic device (10b) to securely transmit a token stored in the first memory (106a) and/or a verification code generated by the verification code generation module (110), said verification code being uniquely associated with a transaction amount and the registered second user, wherein the verification code checking module (112) including the comparator (112a) validates the received code and the extractor module (112b) retrieves the corresponding token, and the authorization module (112c) communicates the token to the first user's bank (40) or a payment gateway/payment aggregator for authorization, after which the transaction server (108) facilitates transfer of funds from the first user's bank (40) to the second user bank (30) and the notification module (118) transmits confirmation of the transaction to the electronic devices (10a, 10b).

FIG. 2 illustrates a flowchart (300) showing the first user's functionality, in accordance with the present disclosure.
At step 302, the flowchart (300) includes begins with downloading an application by a first user on a user device.
At step 304, the flowchart (300) includes the system determining whether the first user is authenticated.
At step 306, the flowchart (300) includes if the first user is not authenticated, authentication details of the first user are entered and verified.
At step 308, the flowchart (300) includes the system determining whether financial instrument details associated with the first user are stored.
At step 310, the flowchart (300) includes if financial instrument details are not stored, the first user inserts financial instrument details into the application.
At step 312, the flowchart (300) includes the first user details and financial instrument details are converted into a tokenized form.
At step 314, the flowchart (300) includes storing the tokenized details in a first memory.
At step 316, the flowchart (300) includes the system determining whether the first user wants to perform payment via the application.
At step 318, the flowchart (300) includes if the first user does not want to perform payment via the application, another payment mode is selected.
At step 320, the flowchart (300) includes if the first user chooses to perform payment via the application, the first user generates a code or PIN.
At step 322, the flowchart (300) includes the first user physically sharing the generated code or PIN with a second user.
At step 324, the flowchart (300) includes the first user receiving a transaction amount from the second user.
At step 326, the flowchart (300) includes the system determining whether the first user wants to proceed with the payment.
At step 328, the flowchart (300) includes if the first user does not want to proceed with the payment, the process ends.
At step 330, the flowchart (300) includes if the first user confirms the payment, an OTP is generated by an issuing bank gateway and the transaction is completed successfully.
At step 332, the flowchart (300) includes details of the second user that are stored in a second memory in the first user's application.
At step 334, the flowchart (300) includes a subsequent transaction with the same recipient is initiated.
At step 336, the flowchart (300) includes the system that determines whether the second user exists in a stored list.
At step 338, the flowchart (300) includes if the second user does not exist in the stored list, the process ends.
At step 340, the flowchart (300) includes if the second user exists in the stored list, the second user is selected from the stored list.
At step 342, the flowchart (300) includes the transaction being initiated using the stored recipient details.
At step 344, the flowchart (300) includes the transaction process being completed.

FIG. 3 illustrates a flowchart (400) showing the second user's functionality, in accordance with the present disclosure; and
At step 402, the flowchart (400) begins with downloading an application by a second user on a user device.
At step 404, the flowchart (400) includes the system determining whether the second user is authenticated.
At step 406, the flowchart (400) includes if the second user is not authenticated, authentication details of the second user are entered and verified.
At step 408, the flowchart (400) includes the system determining whether financial instrument details associated with the second user are stored.
At step 410, the flowchart (400) includes if financial instrument details are not stored, the second user inserts financial instrument details into the application.
At step 412, the flowchart (400) includes the second user's details and financial instrument details, which are converted into a tokenized form.
At step 414, the flowchart (400) includes the tokenized second user details being stored in a first memory associated with the application.
At step 416, the flowchart (400) includes the system determining whether the second user wants to perform payment via the application.
At step 418, the flowchart (400) includes if the second user does not want to perform payment via the application, another payment mode is selected.
At step 420, the flowchart (400) includes if the second user chooses to perform payment via the application, the second user inserts the shared code or PIN into the user device.
At step 422, the flowchart (400) includes the second user entering a transaction amount and sending the transaction request to a payer.
At step 424, the flowchart (400) includes the system determining whether the transaction amount is approved by the first user
At step 426, the flowchart (400) includes if the transaction amount is not approved by the payer, the transaction process ends.
At step 428, the flowchart (400) includes that if the transaction amount is approved by the first user, the transaction amount is received in the second user's bank account.
At step 430, the flowchart (400) includes a subsequent transaction with the same second user that is initiated, repeating the process from step 424.
At step 432, the flowchart (400) includes a stored transaction association that enables faster processing for the same second user.

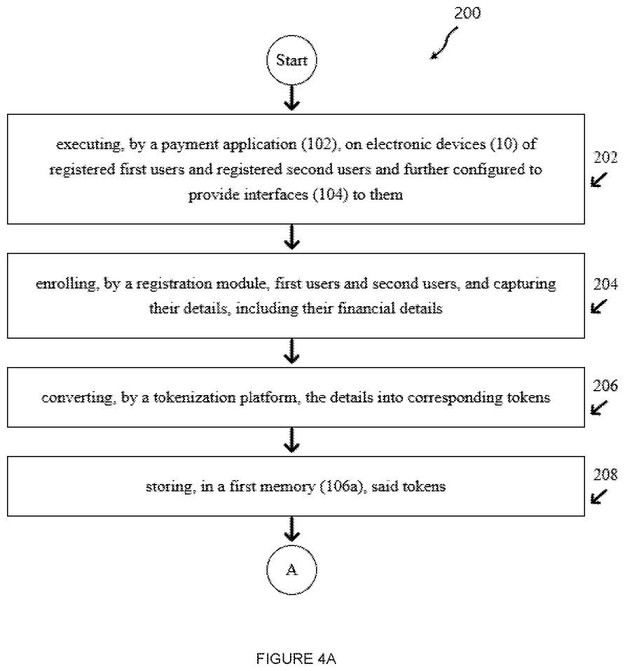

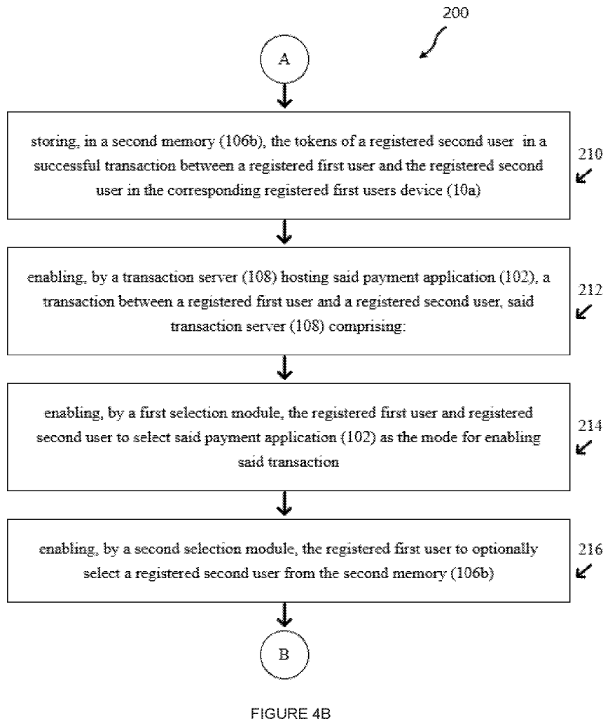

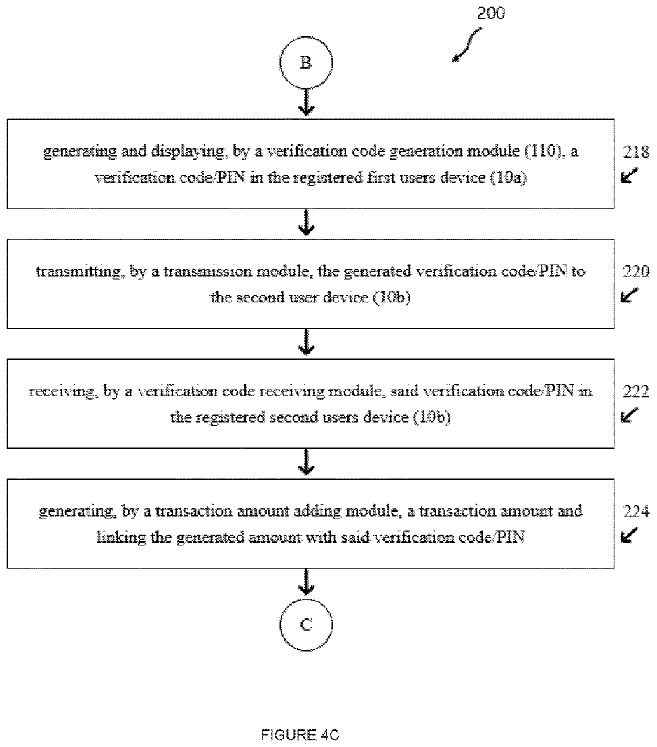

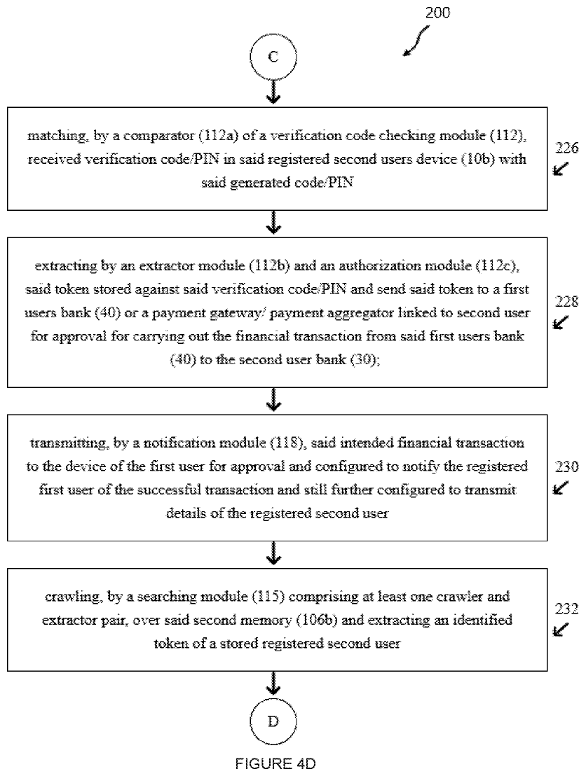

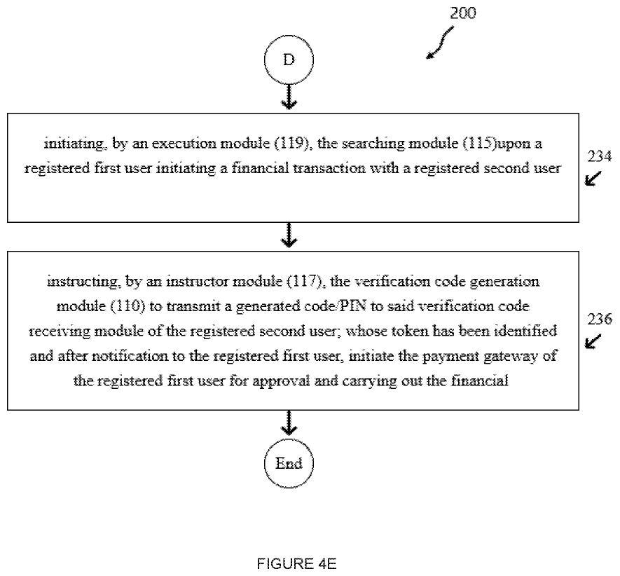

FIGS. 4A to 4E illustrate a method (200) for facilitating a frictionless, secure transaction processing between a registered first user and a registered second user, in accordance with an embodiment of the present disclosure.
At step 202, the method (200) comprises executing, by a payment application (102), on electronic devices (10) of registered first users and registered second users and further configured to provide interfaces (104) to them;
At step 204, the method (200) comprises enrolling, by a registration module, first users and second users, and capturing their details, including their financial details.
At step 206, the method (200) comprises converting, by a tokenization platform, the details into corresponding tokens.
At step 208, the method (200) comprises storing, in a first memory (106a), the tokens.
At step 210, the method (200) comprises storing, in a second memory (106b), the tokens of a registered second user in a successful transaction between a registered first user and the registered second user in the corresponding registered first user's device (10a).
At step 212, the method (200) comprises enabling, by a transaction server (108) hosting the payment application (102), a transaction between a registered first user and a registered second user, the transaction server (108) comprising:
At step 214, the method (200) comprises enabling, by a first selection module (109a), the registered first user and registered second user to select the payment application (102) as the mode for enabling the transaction.
At step 216, the method (200) comprises enabling, by a second selection module (109b), the registered first user to optionally select a registered second user from the second memory (106b).
At step 218, the method (200) comprises generating and displaying, by a verification code generation module (110), a verification code/PIN in the registered first user's device (10a).
At step 220, the method (200) comprises transmitting, by a Transmission module (111), the generated verification code/PIN to the second user device (10b).
At step 222, the method (200) comprises receiving, by a Verification code receiving module (113), the verification code/PIN in the registered second user's device (10b).
At step 224, the method (200) comprises generating, by a Transaction amount adding module (114), a transaction amount and linking the generated amount with the verification code/PIN.
At step 226, the method (200) comprises matching, by a comparator (112a) of a verification code checking module (112), received verification code/PIN in the registered second user's device (10b) with the generated code/PIN.
At step 228, the method (200) comprises extracting by an extractor module (112b) and an authorization module (112c), the token stored against the verification code/PIN and send the token to a first user's bank (40) or a payment gateway/payment aggregator linked to second user for approval for carrying out the financial transaction from the first user's bank (40) to the second user bank (30).
At step 230, the method (200) comprises transmitting, by a notification module (118), the intended financial transaction to the device of the first user for approval and configured to notify the registered first user of the successful transaction and still further configured to transmit details of the registered second user.
At step 232, the method (200) comprises crawling, by a Searching module (115) comprising at least one crawler and extractor pair, over the second memory (106b) and extracting an identified token of a stored registered second user.
At step 234, the method (200) comprises initiating, by an Execution module (119), the Searching module (115) upon a registered first user initiating a financial transaction with a registered second user.
At step 236, the method (200) comprises instructing, by an Instructor module (117), the verification code generation module (110) to transmit a generated code/PIN to the Verification code receiving module (113) of the registered second user; whose token has been identified and after notification to the registered first user, initiate the payment gateway of the registered first user for approval and carrying out the financial transaction from the from the first user's bank (40) to the second user bank (30).

In an embodiment, the method (200) comprises updating personal details and financial details of registered users through the payment application (102).

In an embodiment, the method (200) includes selecting a registered second user from a stored list generated from tokens stored in the second memory (106b) and initiating a transaction using a stored token without re-entering financial details.

In an embodiment, the method (200) includes generating a verification code or PIN that remains valid for a predetermined time period and automatically expiring the verification code or PIN after the predetermined time period or completion of the transaction.

In an embodiment, the method (200) includes generating a verification code or PIN uniquely associated with a predetermined transaction amount and a specific registered second user and authorizing transfer of the predetermined transaction amount exclusively to a bank account associated with the specific registered second user.

The present disclosure provides a system and a method for facilitating frictionless and secure transactions, demonstrated through the following anecdotal examples to illustrate its functionality and practical applications.

In an exemplary embodiment, a registered first user opens the payment application (102) on their electronic device (10a) and accesses the interface (104) to send money to a friend. The first user selects the payment application as the transaction mode using the first selection module (109a), and the execution module (119) triggers the searching module (115) to identify the token of the friend stored in the second memory (106b). The first user selects the friend from the presented list via the second selection module (109b), and the verification code generation module (110) generates a one-time PIN linked to the transaction amount. The PIN is transmitted securely to the friend's device (10b) through the transmission module (111) and received by the verification code receiving module (108). After optional approval by the first user, the verification code checking module (112) validates the PIN, and the extractor module (112b) retrieves the stored token to authorize the transfer via the authorization module (112c) from the first user's bank (40) to the friend's bank (30), with the notification module (118) confirming transaction success.

In another exemplary embodiment, a small business owner uses the payment application (102) on a device (10a) to pay a supplier for a recurring invoice. The first user selects the supplier from the stored token list in the second memory (106b) using the second selection module (109b). The verification code generation module (110) generates a PIN uniquely associated with the invoice amount and supplier, transmitted securely to the supplier's device (10b) through the transmission module (111). The verification code checking module (112) validates the entered PIN, and the extractor module (112b) and authorization module (112c) complete the fund transfer from the first user's bank (40) to the supplier's bank (30). The notification module (118) updates both parties, enabling rapid, frictionless payment without re-entering financial information.

In another exemplary embodiment, a user reimbursing colleagues for shared office expenses opens the payment application (102), and the execution module (119) triggers the searching module (115) to extract tokens of multiple previously transacted colleagues from the second memory (106b). The user selects the colleagues via the second selection module (109b), enters respective transaction amounts, and the verification code generation module (110) generates individual one-time PINs for each transaction. These PINs are securely transmitted via the transmission module (111) to each colleague's device (10b) and validated through the verification code checking module (112). The extractor module (112b) retrieves the associated tokens, and the authorization module (112c) executes the fund transfers from the first user's bank (40) to each colleague's bank (30), with the notification module (118) confirming successful payments.

In another exemplary embodiment, a user sending a birthday gift to a family member selects the recipient from a previously stored list in the second memory (106b) via the second selection module (109b). The verification code generation module (110) generates a one-time PIN linked to the gift amount and transmits it securely through the transmission module (111) to the family member's device (10b). The verification code checking module (112) validates the received PIN, after which the extractor module (112b) retrieves the stored token, and the authorization module (112c) transfers funds from the first user's bank (40) to the second user's bank (30). The notification module (118) confirms the completed transaction, enabling a secure, fast, and frictionless payment experience.

In an exemplary embodiment, a user ordering grocery online selects a previously saved vendor from the second memory (106b) using the second selection module (109b) in the payment application (102). The execution module (119) triggers the searching module (115)to identify the vendor's stored token. The user enters the transaction amount, and the verification code generation module (110) produces a one-time PIN linked to the amount and the vendor. The PIN is transmitted securely via the transmission module (111) to the vendor's device (10b) and validated by the verification code checking module (112). The extractor module (112b) retrieves the stored token, and the authorization module (112c) executes the transfer from the user's bank (40) to the vendor's bank (30), while the notification module (118) confirms the successful payment.

In another embodiment, a user paying for a ride-sharing service selects the driver from a stored list of previously transacted recipients in the second memory (106b) using the second selection module (109b). The verification code generation module (110) generates a one-time PIN tied to the ride fare, which is sent securely via the transmission module (111) to the driver's device (10b). Upon validation by the verification code checking module (112), the extractor module (112b) retrieves the driver's token, and the authorization module (112c) initiates the fund transfer from the rider's bank (40) to the driver's bank (30). The notification module (118) updates both parties with the transaction confirmation, enabling a frictionless payment experience.

In an exemplary embodiment for peer-to-peer gifting, a user selects a family member or friend from previously transacted recipients in the second memory (106b) via the second selection module (109b). The verification code generation module (110) generates a one-time PIN linked to the gift amount, which is transmitted securely via the transmission module (111) to the recipient's device (10b). The verification code checking module (112) confirms the PIN, and the extractor module (112b) retrieves the recipient's token. The authorization module (112c) executes the transaction from the first user's bank (40) to the second user's bank (30), while the notification module (118) provides confirmation to both parties, ensuring the process is fast, secure, and requires no re-entry of sensitive financial details.

In another embodiment involving a subscription service, a user pays for a monthly service by selecting the service provider from the second memory (106b) using the second selection module (109b) in the payment application (102). The execution module (119) triggers the searching module (115) to locate the provider's token. The verification code generation module (110) produces a one-time PIN tied to the subscription amount, transmitted securely to the provider's device (10b) via the transmission module. Once validated by the verification code checking module (112), the extractor module (112b) retrieves the token, and the authorization module (112c) completes the fund transfer from the user's bank (40) to the provider's bank (30). The notification module (118) confirms the transaction, enabling a smooth, frictionless subscription payment.

In an embodiment involving automated teller machines (ATMs), a user selects a previously registered ATM or banking partner stored in the second memory (106b) via the second selection module (109b). The verification code generation module (110) generates a one-time PIN tied to the withdrawal amount and transmits it securely to the ATM device (10b) using the transmission module. The ATM validates the PIN through the verification code checking module (112), after which the extractor module (112b) retrieves the stored token, and the authorization module (112c) enables the withdrawal from the first user's bank (40). The notification module (118) informs the user of a successful cash withdrawal, achieving a frictionless transaction without entering card details.

In an operative configuration, the system (100) enables a registered first user to execute the payment application (102) on their electronic device (10a) to initiate a financial transaction with a registered second user. The first selection module (109a)(108) allows the first user to select the payment application as the transaction mode, while the execution module (119) triggers the searching module (115) to identify a token of the second user stored in the second memory (106b). Using the second selection module (109b), the first user selects the intended recipient, and the verification code generation module (110) generates a one-time PIN uniquely associated with the transaction amount and the selected second user. The PIN is transmitted securely to the second user's device (10b) via the transmission module (111)and received by the verification code receiving module (108). The verification code checking module (112), including the comparator (112a), validates the received PIN, and the extractor module (112b) retrieves the token for the second user. The authorization module (112c) then executes the financial transfer from the first user's bank (40) to the second user's bank (30), while the notification module (118) confirms the successful transaction to both users. This configuration allows the user to complete subsequent transactions using stored tokens, without re-entering full financial details, enabling secure and frictionless payment processing.

Advantageously, the system provides a highly secure and user-friendly method for both first-time and subsequent transactions. By using tokenization, the actual financial details are never exposed or stored in a readable form, reducing the risk of fraud. The one-time PIN generated for each transaction ensures strong authentication, while optional OTP verification further enhances security. For repeated or peer-to-peer payments, the system enables rapid transactions by allowing users to select recipients from stored tokens in the second memory (106b), eliminating the need to repeatedly input sensitive financial information. The combination of secure token management, one-time PINs, and optional OTP approvals ensures that transactions are processed efficiently, reduces friction for users, and supports a wide range of use cases including online merchants, subscriptions, peer-to-peer transfers, and ATM withdrawals, all while maintaining full traceability and confirmation via the notification module (118).

The functions described herein may be implemented in hardware, executed by a processor, firmware, or any combination thereof. Other examples and implementations are within the scope and spirit of the disclosure and appended claims. The present disclosure can be implemented by a processor, hardware, firmware, hardwiring, or combinations of any of these. Features implementing functions may also be physically located at various positions, including distributed such that portions of functions are implemented at different physical locations.

The foregoing description of the embodiments has been provided for purposes of illustration and is not intended to limit the scope of the present disclosure. Individual components of a particular embodiment are generally not limited to that particular embodiment, but, are interchangeable. Such variations are not to be regarded as a departure from the present disclosure, and all such modifications are considered to be within the scope of the present disclosure.

### TECHNICAL ADVANCEMENTS

The present disclosure described hereinabove has several technical advantages including, but not limited to, a system and a method for facilitating frictionless and secure transactions, which:
enable secure transaction processing using tokenized financial information without exposing financial details during transactions;
store tokens corresponding to registered users to enable secure and reusable transaction processing;
store tokens corresponding to previously transacted registered second users for enabling subsequent transactions;
associate stored tokens of registered second users with corresponding registered first users to support repeated transactions;
enable selection of a registered second user from a stored list of previously transacted users;
enable initiation of financial transactions by selecting a previously transacted registered second user without requiring entry of financial details;
enable direct transfer of funds to a selected registered second user using stored token information;
enable execution of subsequent transactions without requiring manual verification by the registered second user;
enable frictionless transaction processing between previously transacted registered users;
enable transfer of funds without requiring re-entry or sharing of financial details;
enable automated retrieval of token information corresponding to a selected registered second user;
enable simplified transaction processing through elimination of repeated authentication steps for subsequent transactions;
enable secure authorization of transactions using stored tokenized information;
enable faster transaction execution using stored transaction associations;
enable seamless repeated transactions between registered users through token reuse;
enable transfer of funds to a predetermined financial account associated with a selected registered second user;
enable protection of user and financial information through token-based transaction processing;
enable secure storage and retrieval of tokens associated with multiple registered second users; and
enable execution of frictionless and secure transactions across multiple transaction environments including point-of-sale terminals, automated teller machines, peer-to-peer transactions, online transactions and merchant devices using a unified transaction mechanism.

The foregoing disclosure has been described with reference to the accompanying embodiments which do not limit the scope and ambit of the disclosure. The description provided is purely by way of example and illustration.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Any discussion of devices, articles, or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. A system (100) for facilitating a frictionless, secure transaction processing between a registered first user and a registered second user, said system (100) comprising:
a payment application (102) configured to be stored and executed on electronic devices (10) of registered first users and registered second users and further configured to provide interfaces (104) to them;
a registration module configured to enroll first users and second users and capture their details, including their financial details;
a tokenization platform configured to convert the details into corresponding tokens;
a first memory (106a) configured to store said tokens;
a second memory (106b) configured to receive the details of a registered second user and store the tokens of a registered second user in a successful transaction between a registered first user and the registered second user in the corresponding registered first user's device (10a);
a transaction server (108) hosting said payment application (102), and configured to enable a transaction between a first user and a second user, said transaction server (108) comprising:
a first selection module (109a) configured to enable the first user and second user to select said payment application (102) as the mode for enabling said transaction;
a second selection module (109b) configured to enable the first user to optionally select a second user from the second memory;
a verification code generation module (110) configured to generate and display a verification code/PIN in the first user's device (10a);
a transmission module (111) configured to transmit the generated verification code/PIN to the second user's device (10b);
a verification code receiving module (113) configured to receive said verification code/PIN in the second user's device (10b);
transaction amount adding module (114) configured to generate a transaction amount and link the generated amount with said verification code/PIN;
a verification code checking module (112) comprising:
a comparator (112a) configured to receive the verification code/PIN in said registered second user's device (10b) and match said received code/PIN with said generated code/PIN;
an extractor module (112b) and an authorization module (112c) configured to extract said token stored against said verification code/PIN and send said token to a first user's bank (40) or a payment gateway/payment aggregator linked to second user for approval for carrying out the financial transaction from said first user's bank (40) to the second user bank (30);
a notification module (118) configured to cooperate with said authorization module (112c) to transmit said intended financial transaction to the device of the first user for approval and configured to notify the registered first user of the successful transaction, and still further configured to transmit details of the registered second user;
a searching module (115) comprising at least one crawler and extractor pair configured to crawl over said second memory (106b) and extract an identified token of a stored registered second user;
an execution module (119) configured to initiate the searching module (115) upon a registered first user initiating a financial transaction with a registered second user; and
an instructor module (117)configured to instruct the verification code generation module (110) to transmit a generated code/PIN to said verification code receiving module of the registered second user; whose token has been identified and after notification to the registered first user, initiate the payment gateway of the registered first user for approval and carrying out the financial transaction from said from said first user's bank (40) to the second user bank (30).

2. The system (100) as claimed in claim 1, wherein the payment application (102) is configured to allow registered users to update stored personal details and financial details.

3. The system (100) as claimed in claim 1, wherein a registered first user is operable as a registered second user in a subsequent transaction, and a registered second user is operable as a registered first user in another transaction.

4. The system (100) as claimed in claim 1, wherein the registration module is configured to capture user details comprising at least one of a username, mobile number, electronic mail address, device identifier, authentication credentials, or financial details.

5. The system (100) as claimed in claim 1, wherein the financial details comprise at least one financial instrument selected from a bank account, debit card, credit card, prepaid instrument, digital wallet, or payment account.

6. The system (100) as claimed in claim 1, wherein the tokenization platform is configured to generate tokens corresponding to financial details such that financial details are not stored in a readable form.

7. The system (100) as claimed in claim 1, wherein the second memory (106b) is configured to store tokens corresponding to previously transacted registered second users, and the second selection module (109b) is configured to present a stored list of registered second users generated from tokens stored in the second memory (106b).

8. The system (100) as claimed in claim 7, wherein the payment application (102) is configured to enable the registered first user to select a registered second user from the stored list, enter a transaction amount through an interface of the payment application (102), and initiate a transaction request for transferring funds from the first user bank (40) to the second user bank (30) using a token corresponding to the selected registered second user without requiring re-entry of financial details.

9. The system (100) as claimed in claim 1, wherein the verification code generation module (110) is configured to generate a verification code or PIN that remains valid for a predetermined time period and automatically expires after the predetermined time period or completion of the transaction.

10. The system (100) as claimed in claim 9, wherein the verification code generation module (110) is configured to generate a unique verification code or PIN uniquely associated with a predetermined transaction amount and a specific registered second user.

11. The system (100) as claimed in claim 10, wherein the verification code checking module (112) is configured to authorize the transaction only when the verification code or PIN is received from the electronic device (10b) associated with the specific registered second user.

12. The system (100) as claimed in claim 10, wherein the verification code checking module (112) is configured to reject the verification code or PIN when used by a registered second user other than the registered second user associated with the verification code or PIN.

13. The system (100) as claimed in claim 10, wherein the verification code or PIN enables transfer of the predetermined transaction amount exclusively to the bank account (30) associated with the registered second user.

14. The system (100) as claimed in claim 1, wherein the transmission module (111) is configured to transmit the verification code or PIN through a secure communication channel.

15. The system (100) as claimed in claim 1, wherein the registered second user comprises at least one of a peer user, an online merchant, a merchant establishment, or an automated teller machine and wherein the verification code generation module (110) is configured to generate a verification code or PIN for enabling withdrawal of funds from the automated teller machine.

16. A method (200) for facilitating a frictionless, secure transaction processing between a registered first user and a registered second user, said method (200) comprising the following steps:
executing, by a payment application (102), on electronic devices (10) of registered first users and registered second users and further configured to provide interfaces (104) to them;
enrolling, by a registration module, first users and second users, and capturing their details, including their financial details;
converting, by a tokenization platform, the details into corresponding tokens;
storing, in a first memory (106a), said tokens;
storing, in a second memory (106b), the tokens of a registered second user in a successful transaction between a registered first user and the registered second user in the corresponding registered first user's device (10a);
enabling, by a transaction server (108) hosting said payment application (102), a transaction between a registered first user and a registered second user, said transaction server (108) comprising:
enabling, by a first selection module, the registered first user and registered second user to select said payment application (102) as the mode for enabling said transaction;
enabling, by a second selection module, the registered first user to optionally select a registered second user from the second memory (106b);
generating and displaying, by a verification code generation module (110), a verification code/PIN in the registered first user's device (10a);
transmitting, by a transmission module, the generated verification code/PIN to the second user device (10b);
receiving, by a verification code receiving module, said verification code/PIN in the registered second user's device (10b);
generating, by a transaction amount adding module, a transaction amount and linking the generated amount with said verification code/PIN;
matching, by a comparator (112a) of a verification code checking module (112) received verification code/PIN in said registered second user's device (10b) with said generated code/PIN;
extracting by an extractor module (112b) and an authorization module (112c), said token stored against said verification code/PIN and send said token to a first user's bank (40) or a payment gateway/payment aggregator linked to second user for approval for carrying out the financial transaction from said first user's bank (40) to the second user bank (30);
transmitting, by a notification module (118), said intended financial transaction to the device of the first user for approval and configured to notify the registered first user of the successful transaction and still further configured to transmit details of the registered second user;
crawling, by a searching module (115) comprising at least one crawler and extractor pair, over said second memory (106b) and extracting an identified token of a stored registered second user;
initiating, by an execution module (119), the searching module (115)upon a registered first user initiating a financial transaction with a registered second user;
instructing, by an instructor module (117), the verification code generation module (110) to transmit a generated code/PIN to said verification code receiving module of the registered second user; whose token has been identified and after notification to the registered first user, initiate the payment gateway of the registered first user for approval and carrying out the financial transaction from said from said first user's bank (40) to the second user bank (30).

17. The method (200) as claimed in claim 16, comprising updating personal details and financial details of registered users through the payment application (102).

18. The method (200) as claimed in claim 16, comprising selecting a registered second user from a stored list generated from tokens stored in the second memory (106b) and initiating a transaction using a stored token without re-entering financial details.

19. The method (200) as claimed in claim 16, comprising generating a verification code or PIN that remains valid for a predetermined time period and automatically expiring the verification code or PIN after the predetermined time period or completion of the transaction.

20. The method (200) as claimed in claim 16, comprising generating a verification code or PIN uniquely associated with a predetermined transaction amount and a specific registered second user and authorizing transfer of the predetermined transaction amount exclusively to a bank account associated with the specific registered second user.
